(19) United States
(12) Patent Application Publication
(10) Pub. No.: US 2014/0101947 A1
(43) Pub. Date: Apr. 17, 2014

(54) Adjustably Positionable Razor Assembly

(71) Applicants: Pedro A. Samuels, North York (CA); Corine R. Samuels, North York (CA)

(72) Inventors: Pedro A. Samuels, North York (CA); Corine R. Samuels, North York (CA)

(21) Appl. No.: 13/653,990

(22) Filed: Oct. 17, 2012

(51) Int. Cl. B26B 21/52

(52) U.S. Cl. CPC B26B 21/521; B26B 21/523
USPC 30/531; 30/527

(57) ABSTRACT

An adjustably positionable razor assembly includes a body. A handle is movably coupled to a top of the body. An articulating member is movably coupled to a bottom of the body. A head is movably coupled to a bottom of the articulating member. A blade is coupled to the head.

### BACKGROUND OF THE DISCLOSURE

### Field of the Disclosure

The disclosure relates to adjustably positionable razor devices and more particularly pertains to a new adjustably positionable razor device for shaving a user's body.

### SUMMARY OF THE DISCLOSURE

An embodiment of the disclosure meets the needs presented above by generally comprising a body. A handle is movably coupled to a top of the body. An articulating member is movably coupled to a bottom of the body. A head is movably coupled to a bottom of the articulating member. A blade is coupled to the head.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a adjustably positionable razor assembly according to an embodiment of the disclosure.

FIG. 2 is a front side view of an embodiment of the disclosure.

FIG. 3 is a left side view of an embodiment of the disclosure.

FIG. 4 is a back side view of an embodiment of the disclosure.

FIG. 5 is a cross sectional view taken along line 5-5 of FIG. 1 of an embodiment of the disclosure.

### DESCRIPTION OF THE PREFERRED EMBODIMENT

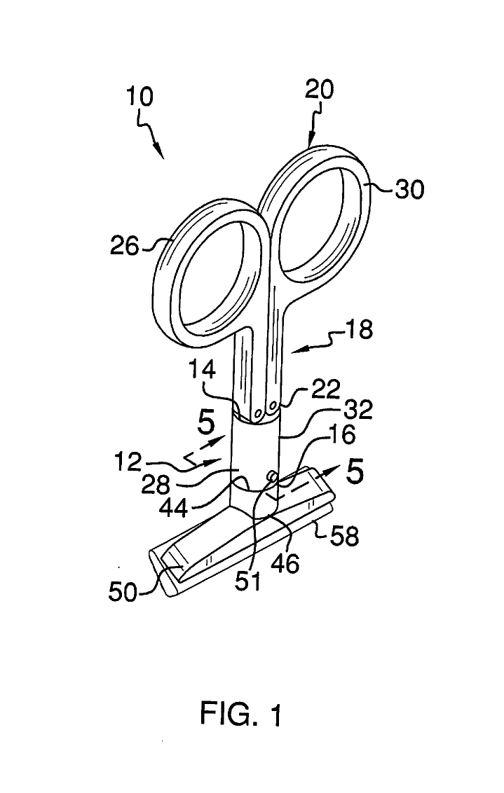

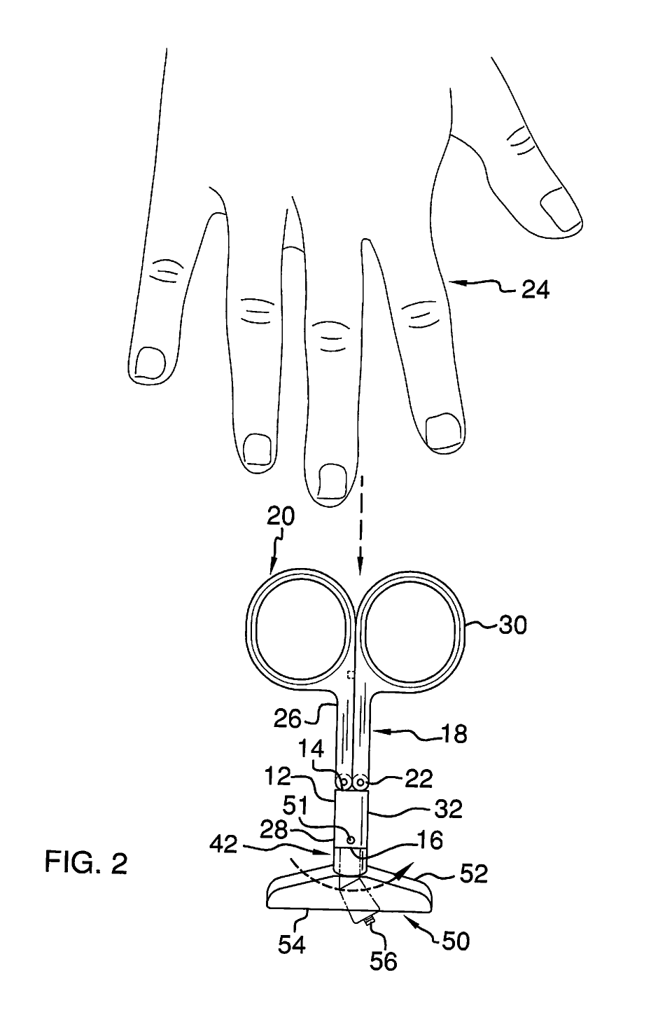

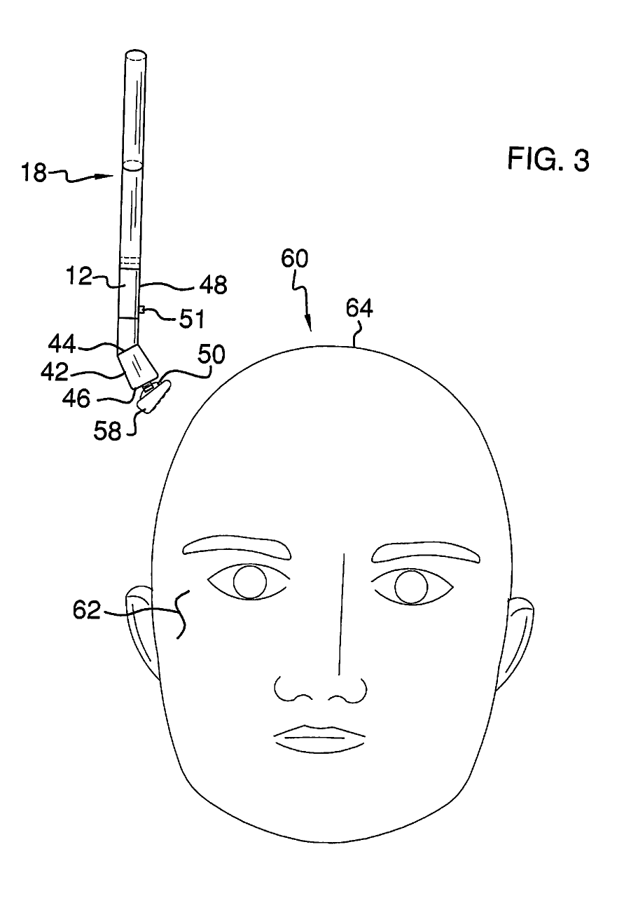

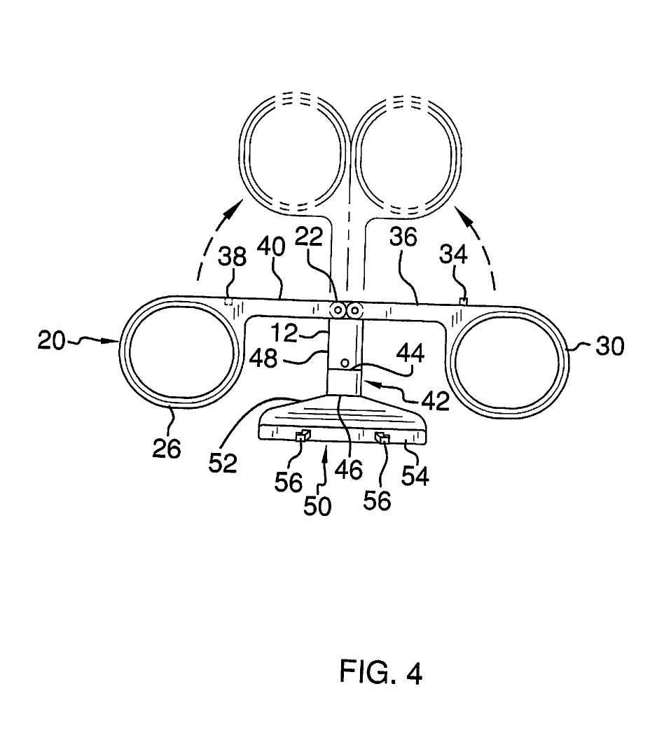

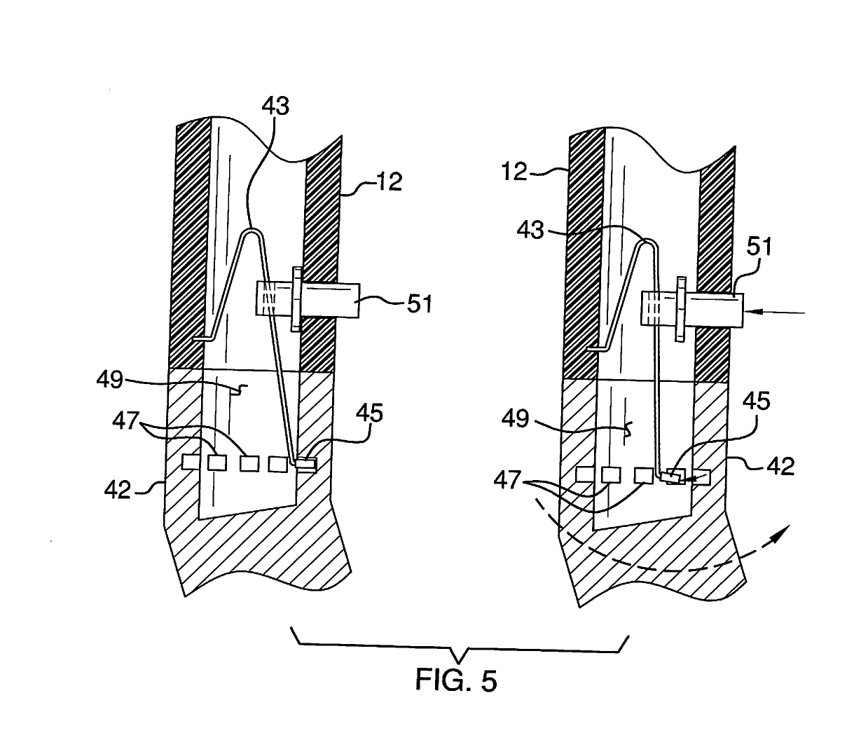

With reference now to the drawings, and in particular to FIGS. 1 through 5 thereof, a new adjustably positionable razor device embodying the principles and concepts of an embodiment of the disclosure and generally designated by the reference numeral 10 will be described.

As best illustrated in FIGS. 1 through 5, the adjustably positionable razor assembly 10 generally comprises a body 12 that has a top end 14 and a bottom end 16. A handle 18 is provided that has a first end 20 and a second end 22. The first end 20 of the handle 18 comprises a closed loop so the first end 20 may gripped by a user 24. The second end 22 of the handle 18 is pivotally coupled to the top end 14 of the body 12. The handle 18 may a length between 3 cm and 5 cm.

The handle 18 is positionable in a deployed position that has the handle 18 extending upwardly from the body 12. The handle 18 is positionable in a stored position that has the handle 18 extending laterally away from the body 12. The handle 18 is one of a pair of the handles 18. A first one of the handles 26 is positioned proximate a first lateral side 28 of the body 12. A second one of the handles 30 is positioned proximate a second lateral side 32 of the body 12.

A tab 34 extends outwardly from a first lateral side 36 of the second handle 30. A groove 38 extends into a second lateral side 40 of the first handle 26. The groove 38 insertably receives the tab 34 when the handles 18 are positioned in the deployed position. The tab 34 may retain the first 26 and second 30 handles in the deployed position. The tab 34 and groove 38 may each be centrally positioned on the associated one of the first 26 and second 30 handles.

An articulating member 42 has a first end 44 and a second end 46. The first end 44 of the articulating member 42 is pivotally and rotatably coupled to the bottom end 16 of the body 12. The articulating member 42 is positionable at a selected angle with respect to a rear side 48 of the body 12. The articulating member 42 is positionable at a selected lateral angle with respect to a longitudinal axis extending through the bottom 16 and top 14 ends of the body 12. The articulating member 42 may be rotated about the longitudinal axis.

A biasing member 43 is coupled to the body 12. The biasing member 43 is positioned within an interior of the body 12 so a free end 45 of the biasing member 43 is biased toward a selected one of a plurality of grooves 47 extending into an inner surface 49 of the articulating member 42. The free end 45 of the biasing member 43 retains the articulating member 42 at a selected rotated position. An actuator 51 is movably coupled to the body 12 proximate the bottom end 16 of the body 12. The actuator 51 selectively engages the biasing member 43 so the free end 45 of the biasing member 43 is urged away from the selected one of the plurality of grooves 47. The articulating member 43 is freely rotatable about the longitudinal axis extending through the body 12 when the actuator 51 is actuated.

A head 50 has a top end 52 and a bottom end 54. The top end 52 of the head 50 is pivotally coupled to the second end 46 of the articulating member 42. The head 50 is positionable at a selected lateral angle with respect to a longitudinal axis extending through the first end 44 and the second end 46 of the articulating member 42. A pair of tabs 56 is coupled to and extends away from the bottom end 54 of the head 50. The head 50 may have a width between 2 cm and 4 cm. A blade 58 engages each of the tabs 56 so the blade 58 may be removably coupled to the head 50. The blade 58 may be positionable on a user's body 60 at a selectable angle with respect to an outer surface 62 of the user's body 60. The blade 58 may be a disposable razor blade of any conventional design.

In use, the assembly 10 may be used with the handles 18 in the deployed or stored position. The articulating member 42 may be rotated about the longitudinal axis to more efficiently shave the user's head 64 or other parts of the user's body 60. The blade 58 may be replaced at any desired interval of time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

We claim:

1. An adjustably positionable razor assembly comprising:
a body;
a handle movably coupled to a top of said body;
an articulating member rotatably coupled to a bottom of said body;
a head movably coupled to a bottom of said articulating member; and
a blade coupled to said head.

2. The assembly according to claim 1, further including said handle having a first end and a second end, said first end of said handle comprising a closed loop whereby said first end is configured to be gripped by a user, said second end of said handle being pivotally coupled to a top end of said body.

3. The assembly according to claim 1, further including said handle being positionable in a deployed position having said handle extending upwardly from said body, said handle being positionable in a stored position having said handle extending laterally away from said body.

4. The assembly according to claim 1, further including said handle being one of a pair of said handles, a first one of said handles being positioned proximate a first lateral side of said body, a second one of said handles being positioned proximate a second lateral side of said body.

5. The assembly according to claim 1, further comprising:
said handle being one of a pair of handles;
said pair of handles being positionable in a deployed position;
a groove extending into a second lateral side of a first one of said handles;
a tab extending outwardly from a first lateral side of a second one of said handles; and
said groove insertably receiving said tab when said handles are positioned in said deployed position whereby said tab is configured to retain said handles in said deployed position.

6. The assembly according to claim 1, further including said articulating member having a first end and a second end, said first end of said articulating member being pivotally and rotatably coupled to a bottom end of said body.

7. The assembly according to claim 1, further including said articulating member being positionable at a selected angle with respect to a rear side of said body, said articulating member being positionable at a selected lateral angle with respect to a longitudinal axis extending through a bottom end and a top end of said body.

8. The assembly according to claim 1, further comprising:
a biasing member coupled to said body, said biasing member being positioned within an interior of said body wherein a free end of said biasing member is biased toward a selected one of a plurality of grooves extending into an inner surface of said articulating member wherein said free end of said biasing member retains said articulating member at a selected rotated position; and
an actuator movably coupled to said body proximate a bottom end of said body, said actuator selectively engaging said biasing member wherein said free end of said biasing member is urged away from the selected one of said plurality of grooves wherein said articulating member is freely rotatable.

9. The assembly according to claim 1, further comprising:
said articulating member having a first end and a second end;
said head having a top end and a bottom end; and
said top end of said head being pivotally coupled to said second end of said articulating member whereby said head is positionable at a selected lateral angle with respect to a longitudinal axis extending through said first end and said second end of said articulating member.

10. The assembly according to claim 1, further comprising:
said head having a top end and a bottom end; and
a pair of tabs coupled to and extending away from said bottom end of said head.

11. The assembly according to claim 1, further comprising:
said head having a top end and a bottom end;
a pair of tabs coupled to and extending away from said bottom end of said head; and
said blade engaging each of said tabs whereby said blade is configured to be removably coupled to said head.

12. The assembly according to claim 7, further comprising:
said head being pivotally coupled to said articulating member;
a pair of tabs coupled to said head;
said blade engaging each of said tabs whereby said blade is configured to be removably coupled to said head, whereby said blade is configured to be positionable on a user's body at a selectable angle with respect to an outer surface of the user's body.

13. An adjustably positionable razor assembly comprising:
a body having a top end and a bottom end;
a handle having a first end and a second end, said first end of said handle comprising a closed loop whereby said first end is configured to be gripped by a user, said second end of said handle being pivotally coupled to said top end of said body, said handle being positionable in a deployed position having said handle extending upwardly from said body, said handle being positionable in a stored position having said handle extending laterally away from said body, said handle being one of a pair of said handles, a first one of said handles being positioned proximate a first lateral side of said body, a second one of said handles being positioned proximate a second lateral side of said body;
a tab extending outwardly from a first lateral side of said second handle;
a groove extending into a second lateral side of said first handle, said groove insertably receiving said tab when said handles are positioned in said deployed position whereby said tab is configured to retain said handles in said deployed position;
an articulating member having a first end and a second end, said first end of said articulating member being pivotally and rotatably coupled to said bottom end of said body, said articulating member being positionable at a selected angle with respect to a rear side of said body, said articulating member being positionable at a selected lateral angle with respect to a longitudinal axis extending through said bottom end and said top end of said body;
a biasing member coupled to said body, said biasing member being positioned within an interior of said body wherein a free end of said biasing member is biased toward a selected one of a plurality of grooves extending into an inner surface of said articulating member wherein said free end of said biasing member retains said articulating member at a selected rotated position;
an actuator movably coupled to said body proximate said bottom end of said body, said actuator selectively engaging said biasing member wherein said free end of said biasing member is urged away from the selected one of said plurality of grooves wherein said articulating member is freely rotatable;
a head having a top end and a bottom end, said top end of said head being pivotally coupled to said second end of said articulating member whereby said head is positionable at a selected lateral angle with respect to a longitudinal axis extending through said first end and said second end of said articulating member;
a pair of tabs coupled to and extending away from said bottom end of said head; and
a blade engaging each of said tabs whereby said blade is configured to be removably coupled to said head, whereby said blade is configured to be positionable on a user's body at a selectable angle with respect to an outer surface of the user's body.
